(19) United States
(12) Patent Application Publication
(10) Pub. No.: US 2011/0094795 A1
(43) Pub. Date: Apr. 28, 2011

(54) WIRE MOLD ASSEMBLY

(76) Inventors: PAUL TERRY, Franklin, NH (US); MARY TERRY, Franklin, NH (US)

(21) Appl. No.: 12/604,395

(22) Filed: Oct. 23, 2009

(51) Int. Cl. H02G 3/18

(52) U.S. Cl. 174/650

(57) ABSTRACT

The present invention relates to a molded assembly to provide a seal at an opening and to allow the transfer of wires or cables comprising: a bottom portion, where said bottom portion fits into the opening to provide a seal; a top portion, where said top portion fits into a slot within the bottom portion; and a plurality of passages formed between the top portion and bottom portion, where the passages allow for the transfer of wires or cables through the opening. In one exemplary embodiment, the molded assembly may include an extender provides that extends the length of the molded assembly by attaching to one end thereof. The molded assembly may further include adjusters that may be used to increase or decrease the diameter of the passages in order to provide a sealing fit for the wire or cables.

### BACKGROUND OF THE INVENTION

1. Field of Invention

The present invention relates to a molded device for allowing the transfer of power wires and Wires through a window or other opening.

2. Description of Related Art

Outdoor decorations, yard work, construction, power outages or charging an electric vehicle frequently requires the use of electrical lights or electrical power tools. In these instances users may desire to connect to power outlets within the building and therefore extend electrical wires to outdoors for connection with the devices, lights or tools that are being utilized. Also, if an individual is operating a generator, then power wires may be transferred inside to supply power to appliances or other devices in the home or building. The transfer of the power wires usually take place through a door opening or a window opening which ever may be most convenient and easiest for the user to use.

Some of the drawbacks related to the transfer of power wires through a window or door openings include the unnecessary transfer of heat or cool air from the indoors and therefore creating an energy loss while its wires are extended to the outdoors. If multiple power wires are required then the wires may consequently become tangled while being transferred through the window opening. Further the window opening may allow the influx of weather such as rain or snow inside the building and therefore creating moisture or dampness that may require clean up. Although people attempt to alleviate some of these problems by placing towels, rags or other devices into the opening, such crude methods are generally ineffective to provide a suitable and complete seal of the opening and allowing the transfer of the power wire as needed.

Consequently the use of a device that effectively seals the opening while extending power wires through the opening would be advantageous for the user. Such a device may provide an effective seal of the opening to allow the extension of power wires, cables or other types of wiring to and from the indoors to outdoor environment.

### SUMMARY OF THE INVENTION

The present invention relates to a molded assembly to provide a seal at an opening and to allow the transfer of wires or cables comprising: a bottom portion, where said bottom portion fits into the opening to provide a seal; a top portion, where said top portion fits into a slot within the bottom portion; and a plurality of passages formed between the top portion and bottom portion, where said passages provide a means to transfer wires or cables through the opening. The molded assembly may include a means to extend the length of the assembly and in one exemplary embodiment an extender provides the means to extend the length by attaching to one end of the molded assembly. The molded assembly may further include adjusters that may be used to increase or decrease the diameter of the passages in order to provide a sealing fit for the wire or cables.

### BRIEF DESCRIPTION OF DRAWINGS

FIG. 1A shows a top view of a mold assembly according to the present invention.

FIG. 1B depicts a front view of the wire mold assembly according to the present invention.

### DETAILED DESCRIPTION

The present invention relates to a mold assembly that provides a means for a seal and a pathway for power cords or cables to transfer through an opening. The mold assembly according to the present invention provides a tight seal so that the opening, usually a window opening, may be sealed tightly around the mold assembly while the mold assembly allows for a passageway for cables or wiring in an organized manner.

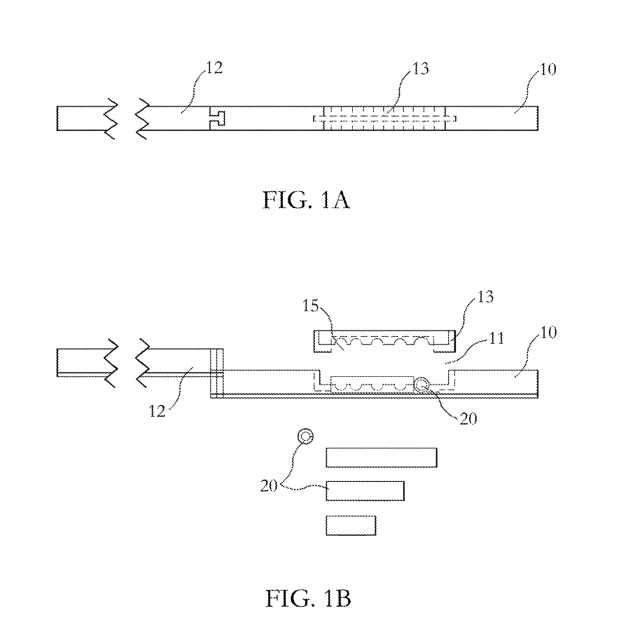

The mold assembly according to the present invention is depicted in FIGS. 1A and 1B. FIG. 1A depicts a top view of the mold assembly according to the present invention. The mold assembly includes a Bottom Portion 10 and a Top Portion 13. The Top Portion 13 and Bottom Portion 10 comprise a standard length of the mold assembly according to the present invention. To accommodate different sized windows or openings an Extender 12 may be attached to the Bottom Portion 10 and provides a means for the extension of the mold assembly to suit various lengths as needed. A front view of the mold assembly according to the present invention is depicted in FIG. 1B. The mold assembly includes a plurality of wire passages 15 between the Top Portion 13 and Bottom Portion 10.

A Slot Opening 11 is provided in the Bottom Portion 10 that abuts to the Top Portion 13 when the Top Portion 13 and Bottom Portion 10 are adjoined. When the Top Portion 13 and Bottom Portion 10 are adjoined the Wire Passages 15 are provided as passageways for power wires and cables as needed.

The number of Wire Passages 15 may vary and therefore provide the user with a multitude of passageways for multiple wires or cables. The Bottom Portion 10 rests within the window opening and once the wires are passed through the Wire Passages 15, the Top Portion 13 is placed within the Slot Opening 11 and on top of the wires that extend through the Wire Passages 15. Once the Top Portion 13 is in place, the window or other opening may be shut closed to abut the mold assembly in its complete form. Various Wire Adjusters 20 are provided to accommodate different sized wires within the Wire Passages 15. The Adjusters 20 ensure that a tight seal remains around the opening once the mold assembly according to the present invention is placed within the opening.

The mold assembly according to the present invention alleviates and eliminates many of the drawbacks associated with the transfer of wires, cords or cables that may extend through a window opening. The transfer of heat or cooled air is reduced or diminished. The wires are prevented from tangling since they are placed within specific wire passages and the influx of outdoor weather elements is eliminated. The present invention allows for the safe transfer of wires through a window opening and the low profile in design eliminates the need for other insulating or molding materials to seal the opening of the window. The instant invention has been shown and described in what it considers to be the most practical and preferred embodiments. It is recognized, however, that departures may be made there from within the scope of the invention and that obvious modifications will occur to a person skilled in the art.

What is claimed is:

1. A molded assembly to provide a seal at an opening and to allow the transfer of wires or cables comprising:
a. a bottom portion, where said bottom portion fits into the opening to provide a seal;
b. a top portion, where said top portion fits into a slot within the bottom portion; and
c. A plurality of passages formed between the top portion and bottom portion, where said passages provide a means to transfer wires or cables through the opening.

2. The molded assembly according to claim 1, where said assembly includes a means to extend the length of the assembly.

3. The molded assembly according to claim 2, where said means to extend the length includes an extender that attaches to one end of the molded assembly.

4. The molded assembly according to claim 1, further comprising adjusters, where said adjusters provide a means to increase or decrease the diameter of the passages in order to provide a sealing fit for the wire or cables.

5. A molded assembly to provide a seal at an opening and to allow the transfer of wires or cables comprising:
a. a bottom portion, where said bottom portion fits into the opening to provide a seal;
b. a top portion, where said top portion fits into a slot within the bottom portion; and
c. At least one wire passage formed between the top portion and bottom portion, where said passages provide a means to transfer wires or cables through the opening.

6. The molded assembly according to claim 5, where said assembly includes a means to extend the length of the assembly.

7. The molded assembly according to claim 6, where said means to extend the length includes an extender that attaches to one end of the molded assembly.

8. The molded assembly according to claim 5, further comprising adjusters, where said adjusters provide a means to increase or decrease the diameter of at least one wire passage in order to provide a sealing fit for the wire or cables.
